(19) United States
(12) Patent Application Publication
(10) Pub. No.: US 2012/0220222 A1
(43) Pub. Date: Aug. 30, 2012

(54) WIRELESS COMMUNICATIONS SYSTEM PROVIDING MEDIA CONTENT BASED UPON NEAR FIELD COMMUNICATION (NFC) COMMUNICATED PREFERENCE INFORMATION AND RELATED METHODS

(75) Inventor: THOMAS C. HILL, Crystal Lake, IL (US)

(73) Assignees: of the Province of Ontario, Canada), Waterloo (CA); Research In Motion Limited (a corporation organized under the laws

(21) Appl. No.: 13/036,400

(22) Filed: Feb. 28, 2011

(51) Int. Cl. H04B 5/00

(52) U.S. Cl. 455/41.1

(57) ABSTRACT

A wireless communications system may include an electronic device including a first near field communication (NFC) device and a player device configured to play media content. The wireless communications system may also include at least one mobile wireless communications device including a second NFC device configured to communicate with the first NFC device based upon proximity, and a controller cooperating with the second NFC device and configured to transmit preference play information to the electronic device via the first NFC device. The player device may be configured to play selected media content based upon the preference play information.

### TECHNICAL FIELD

This application relates to the field of communications, and more particularly, to wireless communications systems and related methods.

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the internet via a cellular network and/or a wireless local area network (WLAN), for example.

Some mobile devices incorporate contactless card technology and/or near field communication (NFC) chips. NFC technology is commonly used for contactless short-range communications based on radio frequency identification (RFID) standards, using magnetic field induction to enable communication between electronic devices, including mobile wireless communications devices. This short-range high frequency wireless communications technology exchanges data between devices over a short distance, such as only a few centimeters.

### BRIEF DESCRIPTION OF THE DRAWINGS

FIG. 1 is a schematic block diagram of a wireless communications system in accordance with an example embodiment.

FIG. 2 is another schematic block diagram of the wireless communications system of FIG. 1 including the display of the mobile device and the electronic device.

FIG. 3 is a schematic diagram of a wireless communications system in accordance with another example embodiment.

FIG. 4 is a flow diagram illustrating example method aspects associated with the system and device of FIGS. 1-2.

FIG. 5 is a schematic block diagram illustrating example components of a mobile wireless communications device that may in accordance with various implementations.

### DETAILED DESCRIPTION

The present description is made with reference to the accompanying drawings, in which embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally speaking, a wireless communications system is disclosed herein which may include a first near field communication (NFC) device and a player device configured to play media content. The wireless communications system may also include at least one mobile wireless communications device including a second NFC device configured to communicate with the first NFC device based upon proximity, and a controller cooperating with the second NFC device and configured to transmit preference play information to the electronic device via the first NFC device. The player device may be configured to play selected media content based upon the preference play information.

The at least one wireless communications device may include a plurality of wireless communications devices. The player device may be configured to play selected media content based upon preference play information from each of the plurality of mobile wireless communications devices, for example.

The player device may be configured to play a plurality of media content channels. The preference play information may include channel preference information. The player device may be configured to play a subset of the plurality of media content channels based upon the channel preference information, for example.

The player device may be configured to play a plurality of media content belonging to at least one of a plurality of categories, for example. The preference play information may include category preference information. The player device may be configured to play selected categories of the media content based upon the category preference information.

The player device may be an audio receiver. The audio receiver may be configured to play a plurality of audio channels. The audio receiver may be configured to play selected audio channels based upon the preference play information, for example.

The player device may include a video receiver. The video receiver may be configured to play a plurality of video channels. The video receiver may be configured to play selected video channels based upon the preference play information.

The player device may include an audio playback device, for example. The audio playback device may be configured to provide a plurality of stored digital audio files. The audio playback device may be configured to play back selected audio files based upon the preference play information. The selected audio files may define an audio playlist, for example.

The player device may include a video playback device. The video playback device may be configured to provide a plurality of stored digital video files. The audio playback device may be configured to play back selected video files based upon the preference play information, for example.

The at least one mobile wireless communications device may include an input device coupled to the controller. The controller may be configured to cooperate with the input device to select the preference play information, for example.

An electronic device, similar to the one described briefly above, and a method for using the electronic device are also provided. The method may include receiving preference play information via the first NFC device from the at least one wireless communications device and playing selected media content using the player device based upon the preference play information, for example.

A related non-transitory computer-readable medium for use with a mobile wireless communications device, such as the one described briefly above, may have computer-executable instructions for causing the mobile wireless communications device to perform various steps. The steps may include receiving preference play information via the first NFC device from at least one wireless communications device comprising a second NFC device and a controller cooperating with the second NFC device and configured to transmit the preference play information to the first NFC device based upon proximity with the second NFC device. The steps may also include playing selected media content using the player device based upon the preference play information, for example.

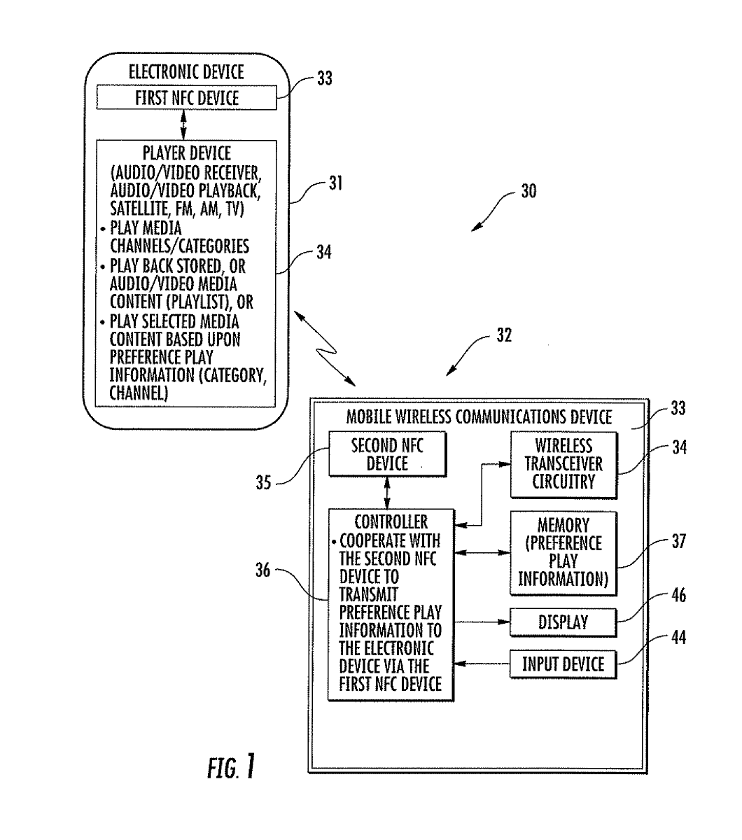

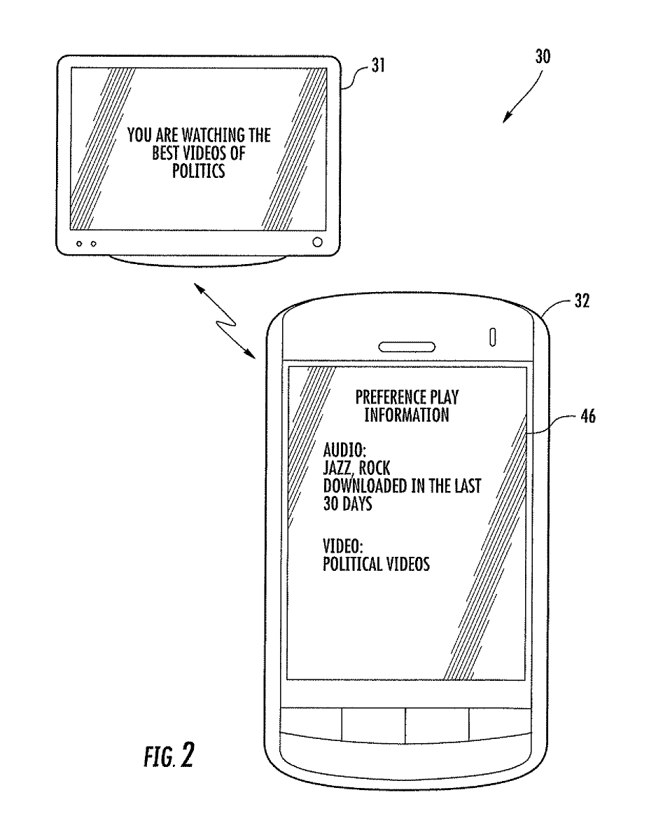

Referring initially to FIGS. 1-2, a wireless communications system 30 is first described. The system 30 illustratively includes an electronic device 31 that includes a first near field communication (NFC) device 33.

By way of background, NFC is a short-range wireless communications technology in which NFC-enabled devices are “swiped,” “bumped” or otherwise moved in close proximity to communicate. In one non-limiting example implementation, NFC may operate at 13.56 MHz and with an effective range of about 10 cm, but other suitable versions of near-field communication which may have different operating frequencies, effective ranges, etc., for example, may also be used.

The electronic device 31 also includes a player device 34 configured to play media content. The player device 34 may play stored media content, may stream media content, or may play live broadcast media content. The player device 34 may play other types of media content.

The system 30 also includes a mobile wireless communications device 32 (also referred to as a “mobile device” herein). Example mobile wireless communications devices may include portable or personal media players (e.g., music or MP3 players, video players, etc.), remote controls (e.g., television or stereo remotes, etc.), portable gaming devices, portable or mobile telephones, smartphones, tablet computers, etc.

The mobile device 32 illustratively includes a portable housing 33 and wireless transceiver circuitry 34 carried by the portable housing. The wireless transceiver circuitry 34 may be cellular transceiver circuitry or other type of wireless communications circuitry (e.g., Wifi, Wimax, etc.), and may communicate any combination of voice and data, such as, for example, email.

The mobile device 32 includes a display 46 carried by the portable housing 33. The display 46 may be a liquid crystal display (LCD) and may be configured to display information relating to data or voice communications. The display 46 may be in the form of an active display that includes a backlight, for example. The display 46 may display email information, contact information, or call information. The display 46 may be another type of display, for example, a passive display, and may display other information.

The mobile device 32 also includes a controller, or processor, 36 that is carried by the portable housing 33 and coupled to the wireless transceiver circuitry 34 and the display 46. The controller 35 may be implemented using hardware (e.g., memory, etc.) and software components, i.e., computer-readable instructions for causing the mobile device 32 to perform the various functions or operations described herein.

The mobile device 32 includes a second NFC device 35 configured to communicate with the first NFC device 33 based upon proximity and cooperating with the controller 36. The controller 36 is configured to transmit preference play information to the electronic device 31 via the first NFC device 33.

The mobile device may include a memory 37 coupled to the controller 36. The preference play information may be stored in the memory 37. The preference play information may be downloaded from a remote computer, for example, a desktop computer (not shown), or wirelessly, for example, via the second NFC device 35, from another mobile device (not shown). The preference play information may be downloaded from other sources. Preference play information may include desired (e.g. favorite) categories, for example, genres of songs, artists, actors, date released, date downloaded, playlist information, etc. Preference play information may also include listening preferences, for example, volume, bass, treble, etc.

The mobile device 32 also includes an input device 44. The mobile device 32 may include more than one input device. The preference play information may, alternatively or additionally, be entered into the memory 37 via the input device 44. The player device 34 plays selected media content based upon the preference play information.

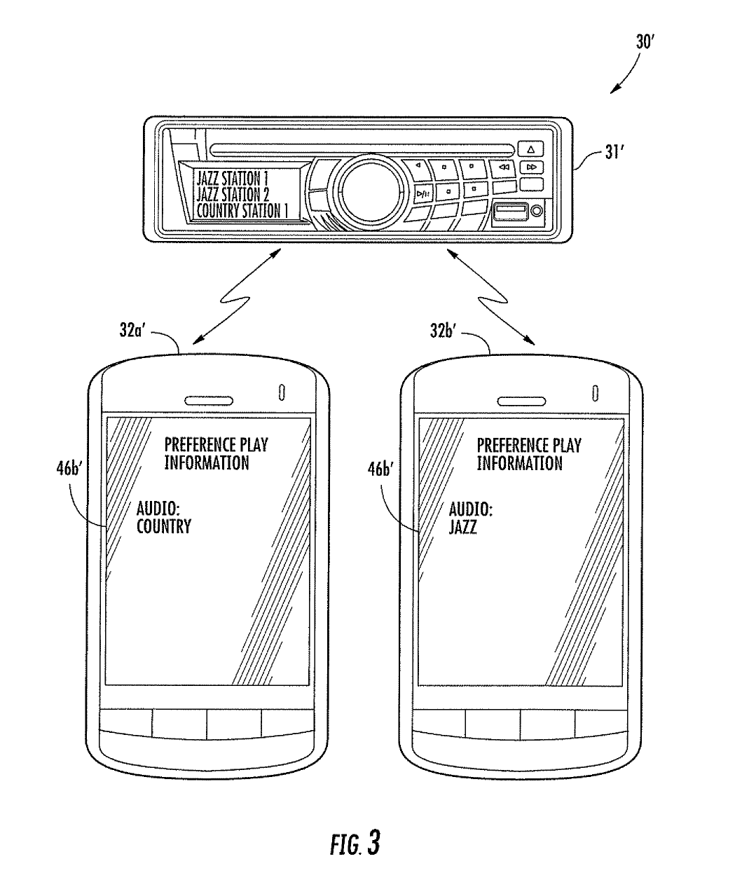

By way of example, the player device 34 may be an audio receiver (See FIG. 3), a video receiver (See FIG. 2), or may receive both audio and video and be configured to play a plurality of media content channels. Media content channels may include one or more of audio and video channels, for example, FM or AM radio stations, TV stations, Internet radio or video stations, and satellite radio stations. The preference play information may include channel preference information, such as a subset of the available channels. The preference play information may include, for example, a listing of favorite stations. The player device 34 plays the subset of available media content channels based upon the channel preference information. In particular, the player device 34 may present the subset of channels as presets that may be selected for play back. Each of the subset of available media content channels may be selectable from the input device, for example.

In another example, the player device 34 may be configured to play media content belonging to at least one category. In such case, the preference play information includes category preference information, for example, a station type, a music genre, etc. The player device 34 plays the selected categories of the media content based upon the category preference information. For example, the media content belonging to a particular genre may be played by the player device 34. The media content may belong to more than one category, and the player device 34 may play the media content that belongs to the selected categories, or may present the different categories as presets. Additionally, the categories may be selectable via the input device 44, for example. The categories may be selected in other ways, for example via NFC communications, or downloaded via a wired or wireless network.

More particularly, in the illustrated example in FIG. 2, the preference play information includes preference play information for political videos. The preference play information for political videos is communicated to the video player device 34. The video player device 34 advantageously plays videos that are politically based, for example.

In still another example, the player device 34 may be a video playback device, for example, a movie player. The video playback device plays back digital video files, for example, movies or videos. The digital video files may be stored may be stored on a player device memory (not shown), for example, or may be stored in another memory, for example in another device (Internet server, etc.). The video playback device 34 plays back selected video files based upon the preference play information, for example, to define a video playlist.

By way of example, the preference play information may include a favorite actor. The video playback device plays, or may provide for playing, videos that have the favorite actor in it. Other types of preference play information may be used to select the video files.

In yet another example, the player device 34 may be an audio playback device, for example, an audio playback device or an MP3 player or other digital music player. The audio playback device 34 plays back stored digital audio files. The digital audio files may be stored on a player device memory (not shown), for example, or may be stored in another memory, for example in another device. The audio playback device 34 plays selected ones of the stored audio files based upon the preference play information. In other words, the selected audio files may define an audio playlist that is played back.

By way of example, the preference play information may include top five favorite bands. The audio playback device 34 plays, or may provide for playing, selected songs that are performed by the top five favorite bands. Other types of preference play information may be used to select the digital audio files.

It should be noted that while several examples of media content, preference play information, and player devices 34 have been described above, a single player device may play both stored media content and media content channels. A single player device may also play both video and audio from any of a number of sources. Alternatively, more than one player device may be included to each perform certain functions, for example, play live, streaming or broadcast video or audio, or play back stored video or audio, and to each play a given type of media content.

Referring now to FIG. 3, in another embodiment, the system 30′ includes a pair of mobile devices 32a′, 32b′. Of course, more than two mobile devices may be used. The player device 34′ is configured to play selected media content based upon the preference play information from each mobile device 32a′, 32b′. By way of example, suppose Bob and Jane enter a vehicle (e.g., a rental vehicle), each carrying their respective mobile device 32a′, 32b′ and wish to set their vehicle's MP3 player or player device 34′. Bob and Jane each place their respective mobile device 32a′, 32b′ in proximity with the first NFC device 33. Their respective preference play information, for example, country and jazz, is transmitted to the MP3 player 34′ via the first NFC device 33. The MP3 player 34′ selects songs from their stored library that meet their respective play preferences, i.e. country and jazz. In other words, the MP3 player 34′ selects and plays only songs in the country and jazz genres. Still further, should Bob and Jane choose to take along their children, the MP3 player 34′ may also select and play songs that also meet their play preferences.

While the preference play information in the present example is different for each mobile device 32a′, 32b′, the preference play information may be the same as or overlapping with other mobile devices in some embodiments. Moreover, while the player device 34′ in the present example is an MP3 audio player, the player device may be another type of player device and may be configured to play or play back more than one or other types of media content, for example, as described above.

Additionally, in another example embodiment, the controller 36 of the mobile device 32 may cooperate with the second NFC device 35 to communicate preference play information to first and second electronic devices 31a, 31b, each having a respective first NFC device 33a, 33b. By way of example, the mobile device 32 may be “bumped” with a home television 31a. The preference play information, for example, channel preference information, is communicated to the home television 31a. The same mobile device 32 may also communicate the same channel preference information when “bumped” with a hotel television 31b, for example, when on the road. In some example embodiments, the home television 31a may transmit preference play information to the mobile device 32, which in turn may transmit the preference play information to the hotel television 31b.

Still further, in another example embodiment, either one or both of the mobile device 30 and the electronic device 31 may save historical preference information, for example, in a respective memory. The saved preference information may be combined, reconciled, or otherwise used as a basis for deriving the preference play information to be transmitted.

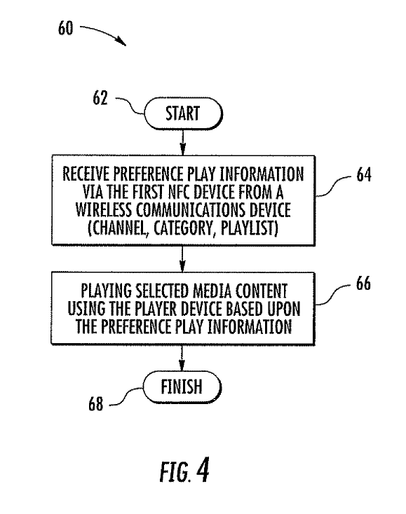

Referring to the flow diagram 60 in FIG. 4, an example method aspect is now described. Beginning at Block 62a method of using an electronic device 31 that includes a first NFC device 33 and a player device 34 configured to play media content. The method includes, at Block 64, receiving preference play information via the first NFC device 33 from a mobile wireless communications device 32. The mobile wireless communications device 32 includes a second NFC device 35 and a controller 36 cooperating with the second NFC device to transmit the preference play information to the first NFC device 33 based upon proximity with the second NFC device. At Block 66, the method includes playing selected media content using the player device 34 based upon the preference play information. The method ends at Block 68.

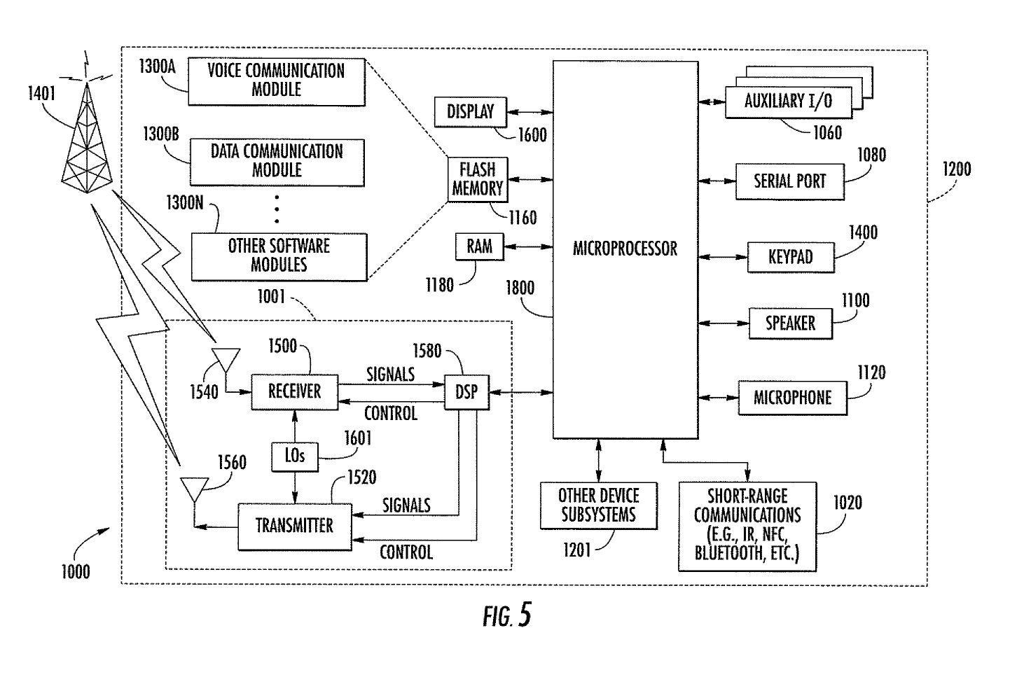

Example components of a mobile wireless communications device 1000 that may be used in accordance with the above-described embodiments are further described below with reference to FIG. 5. The device 1000 illustratively includes a housing 1200, a keyboard or keypad 1400 and an output device 1600. The output device shown is a display 1600, which may comprise a full graphic LCD. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 5. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) sensor for communicating with a NFC device or NFC tag via NFC communications.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A wireless communications system comprising:
an electronic device comprising a first near field communication (NFC) device and a player device configured to play media content; and
at least one mobile wireless communications device comprising
a second NFC device configured to communicate with said first NFC device based upon proximity, and
a controller cooperating with said second NFC device and configured to transmit preference play information to said electronic device via said first NFC device;
said player device being configured to play selected media content based upon the preference play information.

2. The system of claim 1 wherein said at least one wireless communications device comprises a plurality of wireless communications devices; and wherein said player device is configured to play selected media content based upon preference play information from each of said plurality of mobile wireless communications devices.

3. The system of claim 1 wherein said player device is configured to play a plurality of media content channels; wherein the preference play information includes channel preference information; and wherein said player device is configured to play a subset of the plurality of media content channels based upon the channel preference information.

4. The system of claim 1 wherein said player device is configured to play a plurality of media content belonging to at least one of a plurality of categories; wherein the preference play information includes category preference information; and wherein said player device is configured to play selected categories of the media content based upon the category preference information.

5. The system of claim 1 wherein said player device comprises an audio receiver; wherein said audio receiver is configured to play a plurality of audio channels; and wherein said audio receiver is configured to play selected audio channels based upon the preference play information.

6. The system of claim 1 wherein said player device comprises a video receiver; wherein said video receiver is configured to play a plurality of video channels; and wherein said video receiver is configured to play selected video channels based upon the preference play information.

7. The system of claim 1 wherein said player device comprises an audio playback device; wherein said audio playback device is configured to provide a plurality of stored digital audio files; and wherein said audio playback device is configured to play back selected audio files based upon the preference play information.

8. The system of claim 7 wherein the selected audio files define an audio playlist.

9. The system of claim 1 wherein said player device comprises a video playback device; wherein said video playback device is configured to provide a plurality of stored digital video files; and wherein said video playback device is configured to play back selected video files based upon the preference play information.

10. The system of claim 1 wherein said at least one mobile wireless communications device comprises an input device coupled to said controller; and wherein said controller is configured to cooperate with said input device to select the preference play information.

11. An electronic device for communicating with at least one mobile wireless communications device comprising a first near field communication (NFC) device and a controller cooperating with the first NFC device and configured to transmit preference play information to the electronic device, the electronic device comprising:
a second NFC device configured to receive the preference play information from the first NFC device based upon proximity; and
a player device cooperating with said second NFC device and configured to play selected media content based upon the preference play information.

12. The electronic device of claim 11 wherein the at least one wireless communications device comprises a plurality of wireless communications devices; and wherein said player device is configured to play selected media content based upon preference play information from each of said plurality of mobile wireless communications devices.

13. The electronic device of claim 11 wherein said player device is configured to play a plurality of media content channels; wherein the preference play information includes channel preference information; and wherein said player device is configured to play a subset of the plurality of media content channels based upon the channel preference information.

14. The electronic device of claim 11 wherein said player device is configured to play a plurality of media content belonging to at least one of a plurality of categories; wherein the preference play information includes category preference information; and wherein said player device is configured to play selected categories of the media content based upon the category preference information.

15. The electronic device of claim 11 wherein said player device comprises an audio receiver; wherein said audio receiver is configured to play a plurality of audio channels; and wherein said audio receiver is configured to play selected audio channels based upon the preference play information.

16. The electronic device of claim 11 wherein said player device comprises a video receiver; wherein said video receiver is configured to play a plurality of video channels; and wherein said video receiver is configured to play selected video channels based upon the preference play information.

17. The electronic device of claim 11 wherein said player device comprises an audio playback device; wherein said audio playback device is configured to provide a plurality of stored digital audio files; and wherein said audio playback device is configured to play back selected audio files based upon the preference play information.

18. The electronic device of claim 11 wherein said player device comprises a video playback device; wherein said video playback device is configured to provide a plurality of stored digital video files; and wherein said audio playback device is configured to play back selected video files based upon the preference play information.

19. A method of using an electronic device comprising a first near field communication (NFC) device and a player device configured to play media content, the method comprising:
receiving preference play information via the first NFC device from at least one wireless communications device comprising a second NFC device and a controller cooperating with the second NFC device and configured to transmit the preference play information to the first NFC device based upon proximity with the second NFC device; and
playing selected media content using the player device based upon the preference play information.

20. The method of claim 19 wherein the at least one wireless communications device comprises a plurality of wireless communications devices; and wherein the player device plays the selected media content based upon preference play information from each of the plurality of mobile wireless communications devices.

21. The method of claim 19 wherein the player device is configured to play a plurality of media content channels; wherein the preference play information includes channel preference information; and wherein the player device plays a subset of the plurality of media content channels based upon the channel preference information.

22. The method of claim 19 wherein the player device is configured to play a plurality of media content belonging to at least one of a plurality of categories; wherein the preference play information includes category preference information; and wherein the player device plays selected categories of the media content based upon the category preference information.

23. A non-transitory computer-readable medium for use with an electronic device comprising a first near field communication (NFC) device and a player device configured to play media content, and having computer-readable instructions for causing the electronic device to perform the steps comprising:
receiving preference play information via the first NFC device from at least one wireless communications device comprising a second NFC device and a controller cooperating with the second NFC device and configured to transmit the preference play information to the first NFC device based upon proximity with the second NFC device; and
playing selected media content using the player device based upon the preference play information.

24. The non-transitory computer-readable medium of claim 23 wherein the at least one wireless communications device comprises a plurality of wireless communications devices; and wherein the computer-readable instructions are for causing the player device to play the selected media content based upon preference play information from each of the plurality of mobile wireless communications devices.

25. The non-transitory computer-readable medium of claim 23 wherein the player device is configured to play a plurality of media content channels; wherein the preference play information includes channel preference information; and wherein the computer-readable instructions are for causing the player device to play a subset of the plurality of media content channels based upon the channel preference information.

26. The non-transitory computer-readable medium of claim 23 wherein the player device is configured to play a plurality of media content belonging to at least one of a plurality of categories; wherein the preference play information includes category preference information; and wherein the computer-readable instructions are for causing the player device to play selected categories of the media content based upon the category preference information.
